(19) United States
(12) Patent Application Publication
(10) Pub. No.: US 2007/0150821 A1
(43) Pub. Date: Jun. 28, 2007

(54) GUI-maker (data-centric automated GUI-generation)

(76) Inventors: Paul Z. Thunemann, Snoqualmie, WA (US); Michael L. Carter, Sammamish, WA (US); Lonnie J. Princehouse, Seattle, WA (US)

Correspondence Address: John S. Beulick;Armstrong Teasdale LLP, Suite 2600, One Metropolitan Square, St. Louis, MO, 63102, US

(21) Appl. No.: 11/315,902

(22) Filed: Dec. 22, 2005

(51) Int. Cl. G06F 17/00

(52) U.S. Cl. 715/762; 715/760

(57) ABSTRACT

An apparatus and method for creating a data centric graphical user interface (GUI) having XML document, Style(s), unique functionality (if required or desired), and data pair(s). The XML document coded with the Style(s), unique functionality, and data pair(s) are compiled to generate GUIs where the data being displayed is of importance and not the overall layout of the data. Further presented is a system comprising various applications, data, and a data centric GUI. The data centric GUI is used to transfer the data between various applications and across various platforms while allowing for human intervention between applications and formatting of the data most beneficial to the user.

### TECHNICAL FIELD

The present invention relates to a computer-implemented method of automatically generating graphical user interfaces (GUIs). More precisely the present invention relates to a method and software tool configured for rapid GUI prototyping, creation, automation and customization.

### BACKGROUND OF THE INVENTION

A graphical user interface (GUI) is a very powerful and convenient method to view and/or manipulate data. GUIs have been around since the early 1970's and saw rapid advancement in the mid 1980's through the mid 1990's. Basically, a GUI is a program interface that takes advantage of the computer's graphics capabilities to make the program easier to use. Well-designed graphical user interfaces can free the user from learning complex command languages. GUIs consist of some graphical widgets (icons, check boxes, menus) and a pointing device (a mouse or touch screen display). There are various types of GUIs. Some are application specific (ATM machines) while others are customizable (web pages). Examples include the Windows® operating system or the terminals found at self-checkout lines in department stores. A well-designed GUI frees the user from learning complex commands that must be typed at a command prompt.

The creation of GUIs is very involved. Designers have a lot of control and flexibility over the arrangement, color, shape, size, and other characteristics of the widgets being displayed on the screen. With this control and flexibility comes complexity. Frequently, designers would like to have a simple GUI for viewing and modifying data. In many instances, the exact definition of the GUI will change over the development process. This is problematic because creation of a GUI takes a great deal of time and requires a great deal of computer programming skills. It is a highly inefficient programming process because GUIs are often created for single applications. It can be very difficult to extend and modify these GUIs as the requirements are refined or changed. In addition, GUIs that are customized for a specific application frequently have little or no transferability for use with other applications. In some cases, this inefficient use of time and the cost associated with GUI creation causes programmers to do without a GUI. There is a need for a tool and method of prototyping and creating GUIs that is not as time intensive as prior methods. Such a system would allow a user with a data set to quickly create a GUI to manipulate and view that data set.

Typically, traditional GUI development centers on visual appearance. A great amount of detailed information is used to create GUIs that have a specific layout and appearance. Widgets are placed in exact locations; given precise colors; and even fanciful geometric configurations. The idea is that such highly structured GUIs will be user friendly. There is a need for a method and tool that generates a GUI that is defined primarily by the data that it contains and organizes that data on the screen with little or no additional input.

### SUMMARY OF THE INVENTION

The present invention comprises a method implemented by a software tool configured to expeditiously produce GUIs that are “data centric.” The data centric GUIs of the present invention are created by defining the data rather than defining the GUI. The data is defined in a data definition file as name/data type/value triplets that are organized into one or more groups within a single data set. The GUI generation tool is a software application that processes a data definition file and generates the GUI there from. The user of the GUI generation tool can control the look and feel of the GUI by associating predetermined style controls with the data set, groups and or data items within the data definition file. The style controls are mapped to an associated style algorithm that defines how the data should be represented on the screen. The user of the GUI generation tool can also control and create unique functionality of objects within the GUI by associating predetermined functionality controls with the data set, groups and/or data items within the data definition file. The functionality controls are mapped to an associated functionality algorithm. It is an object of the invention to allow the user to create a GUI while focusing on the data rather than the GUI. It is a further object of the invention to facilitate easy development, rapid prototyping, automation and easy customization of the appearance of the GUI for different users. The association of style and functionality controls is accomplished by referencing a specific style and functionality to data within the data definition file.

Embodiments may be implemented as a computer process, a computer system or as an article of manufacture such as a computer program product. The computer program product may be a computer storage medium readable by a computer system and encoding a computer program of instructions for executing a computer process. The computer program product may also be a propagated signal on a carrier readable by a computing system and encoding a computer program of instructions for executing a computer process.

### BRIEF DESCRIPTION OF THE DRAWINGS

Non-limiting and non-exhaustive embodiments are described with reference to the following figures, wherein like reference numerals refer to like parts throughout the various views unless otherwise specified.

FIG. 1 illustrates the process of creating a data centric GUI;

FIG. 2 illustrates the high level structure of the GUIGenerator;

FIG. 3 illustrates interim steps of the process of creating a data centric GUI;

FIG. 4 illustrates the steps to construct the GUI;

FIG. 5A illustrates a simple data centric GUIs created using the present invention;

FIG. 5B illustrates a simple data centric GUIs created using the present invention;

FIG. 6 illustrates a data centric GUI created using the present invention with multiple page instances;

FIG. 7 illustrates a data centric GUI created using the present invention with multiple pages and multiple instances of the “person” page; and

FIG. 8 illustrates a system for creating data centric GUIs.

### GENERAL DESCRIPTION OF THE INVENTION

The present invention is a method of expeditiously creating data centric GUIs. One key innovation of this invention is the separation of the definition of the data in the GUI from the definition of the GUI itself. In the present embodiment, the data is defined in a “data definition file”. The data definition file is organized into one or more groups, and each group contains one or more data items. Each data item is comprised of a data triplet, including name, data type and value. Groups are a special case as they contain data items and may also be data items. Groups are also special because they can be defined to exist as a single instance, or they can exist as a multiple instance where the same data items exist as a group multiple times. This data definition file may then be read by a programming algorithm, which is referenced throughout this document as the “GUIGenerator”. The GUIGenerator automatically creates a GUI from its processing of the data definition file. It will determine the look and feel of the GUI. It will determine how a user navigates between the groups of data in the data definition file. And, it will determine the layout of each of those groups and the precise widgets that are used to represent each data item. If a user does not select any additional information, the GUIGenerator will generate the GUI in some predetermined, default manner.

It is contemplated that the data set may also include information referencing select Styles, thereby overriding the predetermined default configuration of GUI components. There is a set of Styles referred to as “data styles”, which can be referenced by the entire data set. If no data style is referenced, then a default Style is used. Data Styles determine the layout of the entire GUI window, and how one navigates between the different Groups of data. There is a set of styles referred to as “group styles”, associated with each of the Groups. If no Group Style is referenced within the data definition document by a particular Group, then the Group is assigned the default Group Style as determined by the data Style of the entire data set. The Group Style determines the layout of the widgets that are needed to represent the data items of the Group. The Group Style also controls the size of each of these widgets depending on the number and type that need to be displayed. Lastly, there is a set of Styles that are unique to each data type. These data Styles determine the type of widgets that will be used to represent the data. If a data item does not refer to one of its Styles, then one of its styles will be assigned to it by default as determined by the Group Style of the Group that contains the data item.

While control of GUI appearance is important, it is also vital to be able to add unique functionality to the GUI. Some GUI functionality is handled automatically—navigating between pages, error checking text fields to ensure they contain the correct data type, and writing out the GUI's current state into a data definition file are examples of things that are automatically enabled by the GUIGenerator. Other GUI functionality will be application specific, and will need to be programmed specifically for those applications. This is handled by “event listeners”. The user can reference “event listeners” to be associated to a particular data item or Group or to the entire data set. The “event listener” is then associated with that particular data item, Group or the data set, and the method that the listener contains is invoked whenever that data item, group or data set declares that an event has occurred.

It is an object of the present invention to allow the user of the GUIGenerator to create a GUI while focusing on the data rather than the GUI. By focusing on the data, initial development becomes very easy. The ability to prototype different GUI designs becomes real-time, allowing the user to define the data requirements to the developer while nearly simultaneously looking at a prototype of the end product. Since the data within the data definition file defines the GUI, the GUI can be created based on a data set that is the output of some automated process. Not only can the user view the output of some automated process via the GUIGenerator, but it also functions to allow a user to tap into application-application interfaces. Another benefit of separating the data from GUI generation is that the style/appearance/layout is independent of functionality, so customization of the appearance and layout can be radically different for different users, but the underlying functionality can be the same.

Various embodiments are described more fully below with reference to the accompanying drawings, which form a part hereof, and which show specific exemplary embodiments for practicing the invention. However, embodiments may be implemented in many different forms and should not be construed as limited to the embodiments set forth herein; rather, these embodiments are provided so that this disclosure will be thorough and complete, and will fully convey the scope of the invention to those skilled in the art. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

The logical operations of the various embodiments are implemented (a) as a sequence of computer implemented steps running on a computing system and/or (b) as interconnected machine modules within the computing system. The implementation is a matter of choice dependent on the performance requirements of the computing system implementing the embodiment. Accordingly, the logical operations making up the embodiments described herein are referred to alternatively as operations, steps or modules.

### DETAILED DESCRIPTION OF THE INVENTION

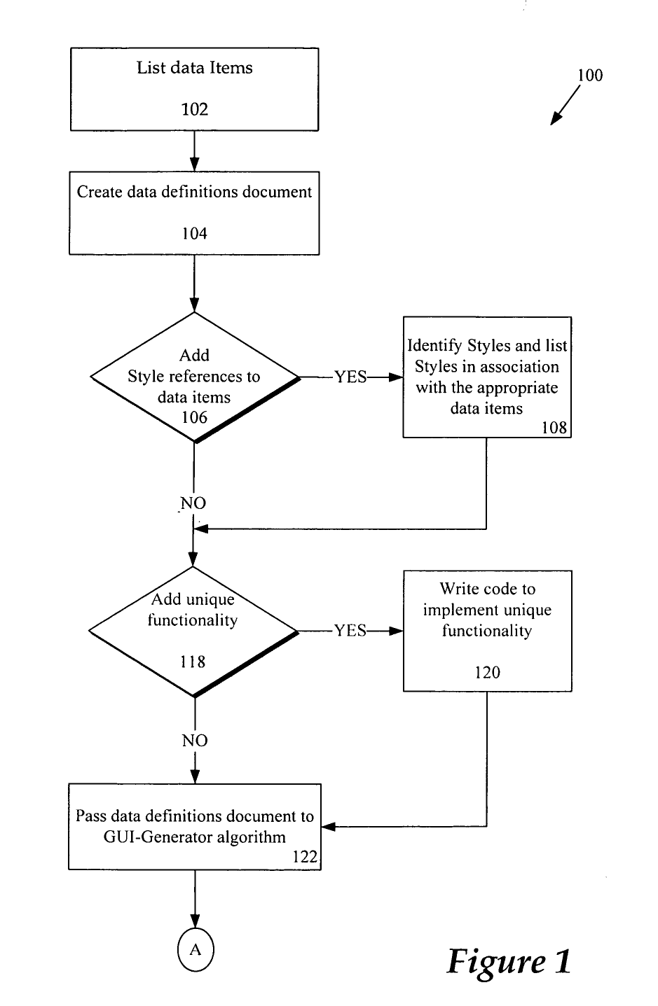

Referring more particularly to the drawings, a method for creating a graphical user interface (GUI) that is data centric in accordance with the principles of the present invention is illustrated schematically in FIG. 1 and indicated by reference numeral 100. FIG. 1 illustrates the basic steps for creating a data centric GUI. A conceptual list of grouped data triplets is defined 102. Each data triplet contains a name, a data type and a value and is referred to as a data item. The value of each data triplet is optional and may be left unstated, in which case a “null” is the assumed value.

The data type(s) can be any data structure that has been previously defined to be used by the process such as: Arrays, Booleans, Files, Integers, Lists, Pointers, Strings, Tables, etc.

Once the conceptual list of data items are defined 102, a data definition document is created 104. In the present embodiment, the document created is an XML document, which can be created using standard XML generation techniques. In this XML document, the first XML node is a “Data” node, which may contain one or more “Group” nodes, each of which may contain one or more “Data Item” nodes. Next, the user decides whether modifications to the default GUI is warranted by determining whether to add style references to data items, groups or the data with the data definition document 106. If the user decides to use a non-default style, this is done by adding a style attribute to the particular data item, group or data that is to be modified. The value of the style attribute has to be chosen from a discrete list of selectable option 108.

There are a variety of data styles, group styles and data item styles from which a user may select to associate with the data, groups or data items. If the user does not supply a style, then a default style will be selected. For example, a default group style might simply display each of the data items in the order that they appear in the XML document. A very simple alternative to the default style may display each of the data items in alphabetical order. Another alternative style might order them in terms of data type. Another alternative to the default style might list the data items in more than a single row. Likewise, a default data item style might display a data item with an integer data type as a text field, while another style might display it as a slider bar. A default data style might allow the user to navigate between the groups using buttons on the right hand side of the window, while another style might allow navigation with tabs across the top of the window. There are limitless numbers of possible styles. As the GUI developer creates data centric GUIs for various needs, their library of possible styles will be expanded

Once a determination is made as to whether to associate a style reference with a data item within the data definition document, a determination is made of whether unique functionality may need to be added 118 to the data centric GUI. If there are any unique functionality requirements, the proper code can be written 120 and included within the data definition document. Unique functionality may include multiple functions unique to a specific group of user(s) such as the ability to retrieve information from a database, modify and save information to a database. Other examples of unique functionality might be password protection of data; a frame, page, and/or a data listener to automatically update dependent data value(s) if an independent data value is altered. The number of unique functions is limitless.

After the data definition document has been created 104 and the appropriate style references added 108, along with any desirable unique functionality 120, the data definition document is loaded into the GUIGenerator 122 for processing. This GUIGenerator includes an algorithm that can be written in either a compliable language or an interpretive programming language. For example, the GUIGenerator algorithm can be written using C/C++, Java-Swing, Servlets, or Visual Basic. The GUIGenerator's source code can be transferred across various platforms such as Macintosh®, Linux, Solaris®, Windows®, and/or UNIX.

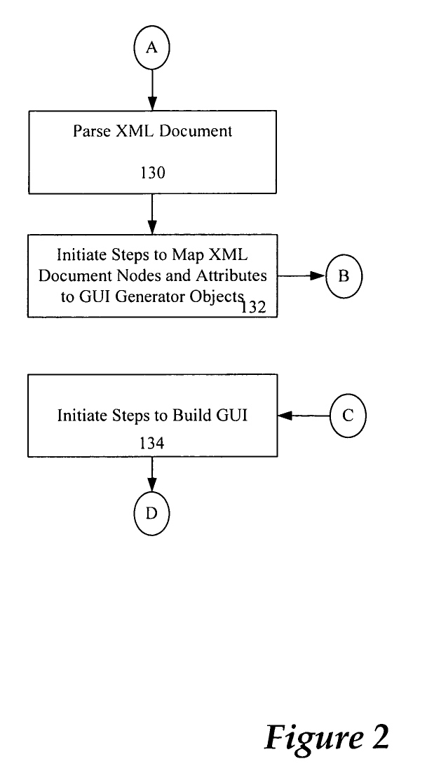

FIGS. 2, 3, and 4 depict the process implemented by the GUIGenerator. FIG. 2 shows the high level structure of the GUIGenerator. First, the GUIGenerator will parse the XML document 130 and initiate steps to map XML document nodes and attributes to GUIGenerator objects 132. Once this is complete the GUIGenerator will initiate the steps necessary to build the actual GUI 134.

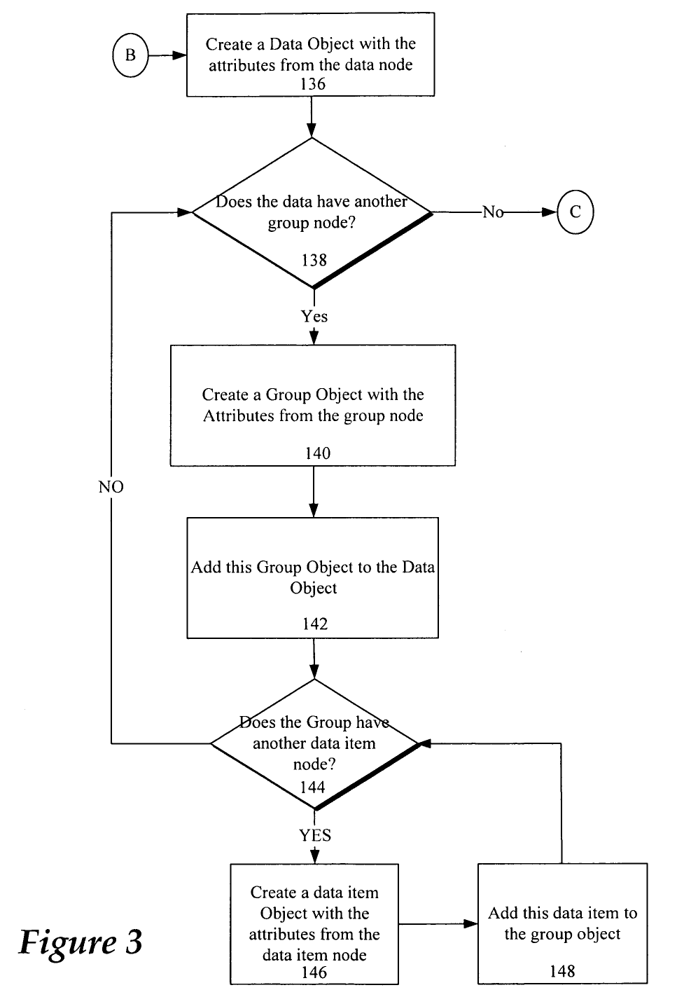

FIG. 3 depicts the steps necessary to parse the XML document 130 and map the XML document nodes and Attributes to the GUIGenerator objects 132. First, the data objects are created with the attributes from the data node 136. After the data objects have been created 136, the GUIGenerator will check to see if there are group nodes that need to be processed 138. If there are no group nodes to be processed then the GUIGenerator will initiate steps to build the actual GUI 134. If there are group nodes to be processed then the GUIGenerator will create a group object with the attributes from the group node 140 and add the group object to the data objects 142.

After creating a group object 140 and adding the group object to the data object 142, the GUIGenerator will then check to see if the group node has any data item nodes that need to be processed 144. If there are no data item nodes that need to be processed then the GUIGenerator will check to see if there are more group nodes to process 138. If there is another data item node to process then the GUIGenerator will create the data item object with the attributes from the data item node 146 and add the data item to the group object 148. Once the last group is complete the GUIGenerator will initiate steps to build the actual GUI 134.

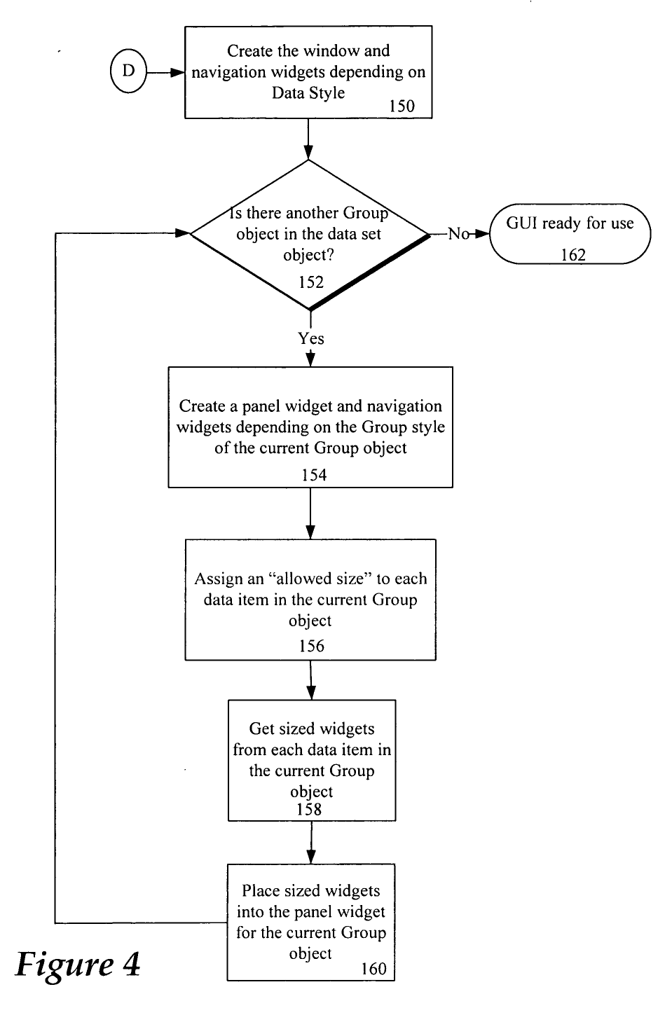

Once the XML document has been parsed 130 and the XML document nodes mapped 132, the GUIGenerator initiates steps to build the actual GUI and all of its widgets 134. FIG. 4 depicts the steps to construct the GUI. First, the GUIGenerator will create the window and navigation widgets 150. The window and navigation widgets are created according to the data style.

After the creation of the window and navigation widgets 150, the GUIGenerator will determine if there are Group objects in the data set that need to be processed 152. If there are no Group objects left unprocessed, the GUI is ready for use 162 and it should be made visible to the appropriate system. If there are Group objects that need to be processed, the GUIGenerator will process one of the Group objects. It will first create the panel and navigation widgets 154 for the Group object. The panel and navigation widgets are created in accordance with the group style for that Group object. Once the panel and navigation widgets are created 154 the GUIGenerator will assign an allowed sized to each data item 156. Once the data item knows its allowed size, it will resize all of the widgets that it needs to display to fit within its allowed size. Next, the sized widgets from each of the data items will be retrieved from each of the data items 158, and then the widgets will be placed in the panel of the current Group object 160. Once the Group is complete the GUIGenerator will determine if there is another Group to be processed 152 and continue creating Group objects until the last Group object is complete. After the last Group object is complete the GUI will be ready for use 162.

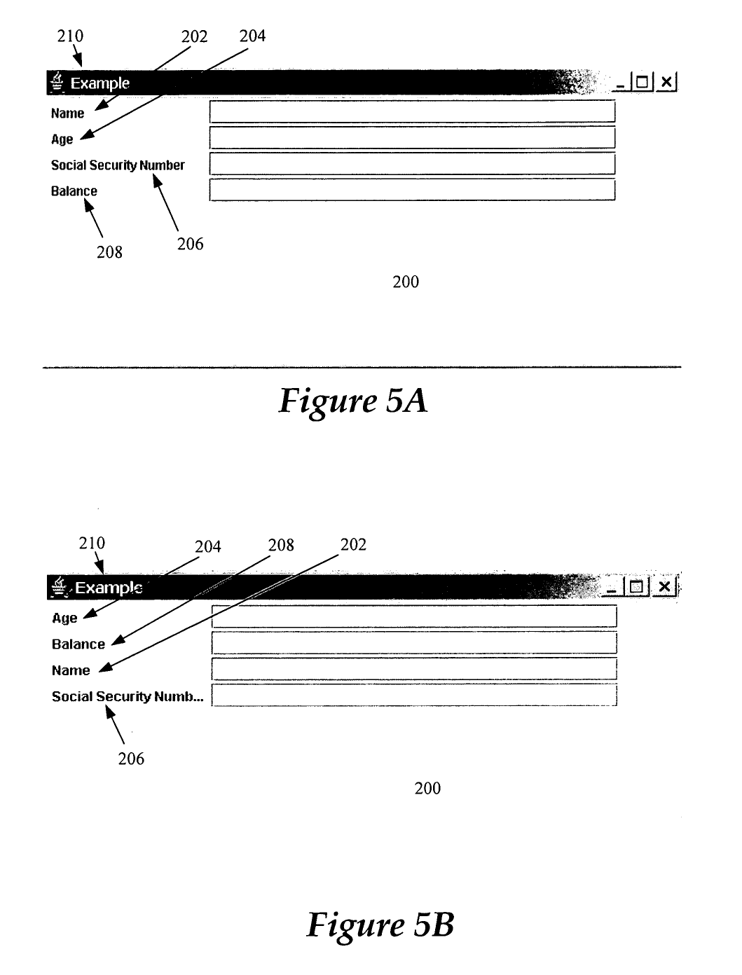

Examples of data centric GUIs created using the present invention are illustrated in FIGS. 5-7. FIG. 5A depicts a simple data centric GUI 200, illustrating typical information that might be important to a bank teller; such as Name 202, Age 204, Social Security Number 206 and Account Balance 208. The Data items within the “person” Group within the “example” data set that are required to generate GUI 200 are written in the following XML code:

<Data name = “example” style = “default”>

<Group name = “person” style = “default” functionality = “single
instance”>

<String name = “Name”/>
<Integer name = “Age”/>
<Integer name = “Social Security Number”/>
<Double name = “Balance”/>

</Group>

</Data>

As illustrated above, the data items “Name”, “Age”, “Social Security Number”, and “Balance” are comprised of data triplets, including name, type and value. For the “Age” data item, the name=“Age”, type =“Integer” and the value is left blank. The GUI Data set name 210 has the label “example” and defines the window. It also includes a Style reference, “default”. Within the Example window, there is a Group that includes a “default” Style that has single instance functionality.

In XML data files such as that identified above, at the highest level, there is a data set. In this example, it is labeled “example”. The “example” data set contains one Group that is labeled “Person”. However, it is to be understood that the data set may contain one or more Groups. Within each Group, there is a plurality of data items. The user may decide to associate Style or some unique Functionality at the Data set level, the Group level or for select data items.

In the example above, the Group level has a default Style and single instance Functionality. This means that there is a “single instance” of a “person” within the Group having a “default” Style.

FIG. 5B depicts the GUI from FIG. 5A modified by changing the Style reference at the Group level. FIG. 5B is a simple data centric GUI with typical information that might be important to a bank teller: such as Name 202, Age 204, Social Security Number 206 and Account Balance 208. The Data and Style(s) references required to generate GUI 200 are written in the following XML code:

<Data name = “example” style = “default”>

<Group name = “person” style = “alphabetic” functionality = “single
instance”>

<String name = “Name”/>
<Integer name = “Age”/>
<Integer name = “Social Security Number”/>
<Double name = “Balance”/>

</Group>

</Data>

The GUI Data set name 210 is “example” and the referenced Style for the Data set is “default”. As illustrated, the Data set name 210 defines the window name and the Style for the data set defines the style of the window. The style illustrated is a default. Within the Example window defined, there is Group name that includes an “alphabetic” Style that has single instance functionality. This means that there is a “single instance” of a “person” page wherein the data items are listed in alphabetical order in accordance with the “alphabetic” Style.

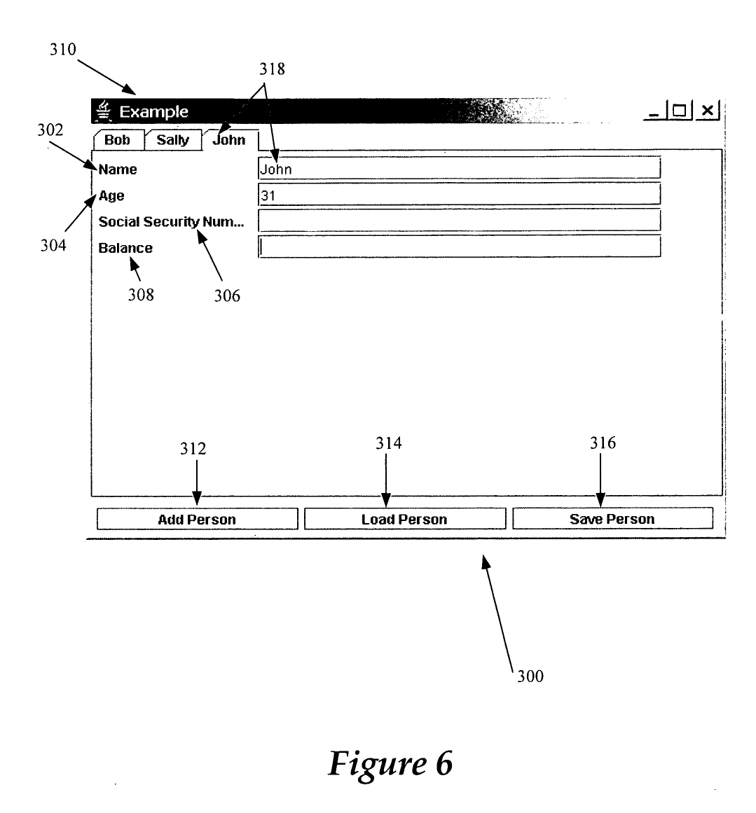

FIG. 6 shows a data centric GUI created using the present invention indicated by reference numeral 300. FIG. 6 depicts a GUI showing typical information that might be important to a bank teller; such as Name 302, Age 304, Social Security Number 306 and Account Balance 308. The Data items and associated Style(s) and Functionality references required to generate GUI 200 are written in the following XML code:

<Data name = “example” style = “default”>

<Group name = “person” style = “default” functionality = “multiple
instance”>

<String name = “Name”/>
<Integer name = “Age”/>
<Integer name = “Social Security Number”/>
<Double name = “Balance”/>

</Group>

</Data>

The GUI Data set name 310 is “example” and the Style of the data set is “default”. As illustrated, the Data set name 310 defines the window name and the Style defines the style of the window. The Style illustrated is a default. Within the Example window defined, there is Group name that references a “default” Style and a multiple instance Functionality. This means that there are multiple instances of a “person” page having a “default” Style. The data is listed in the order in which the XML document source code lists the data on each page. As FIG. 6 illustrates, a first page 318 of three pages having an person's name “John” and age “31” input is displayed. The remaining two pages of the multiple instance of a person for “Bob” and “Sally” are hidden. Each page has a tab 318 that can be used to bring any of the multiple instances to the front and hide the remaining multiple instances.

FIG. 6 also depicts unique functionality added (step 120 from FIG. 1) to the data centric GUI. The data centric GUI shown in FIG. 6 allows a bank employee (bank teller) to load a person(s) 314 from a database, possibly the bank's customer list. Suppose a potential new customer would like to open an account with the bank. Another unique functionality of the data centric GUI provides the ability to add a person 312. A Page listener is also incorporated to update the page name 318 once the data value “Name” has been inputted. Once the person has been created (account opened) and all the relevant data value(s) entered or an account has been manipulated (i.e. deposit interest income to the customer's account or debit surcharges, etc.) the bank personal has the ability to save a person's 316 data.

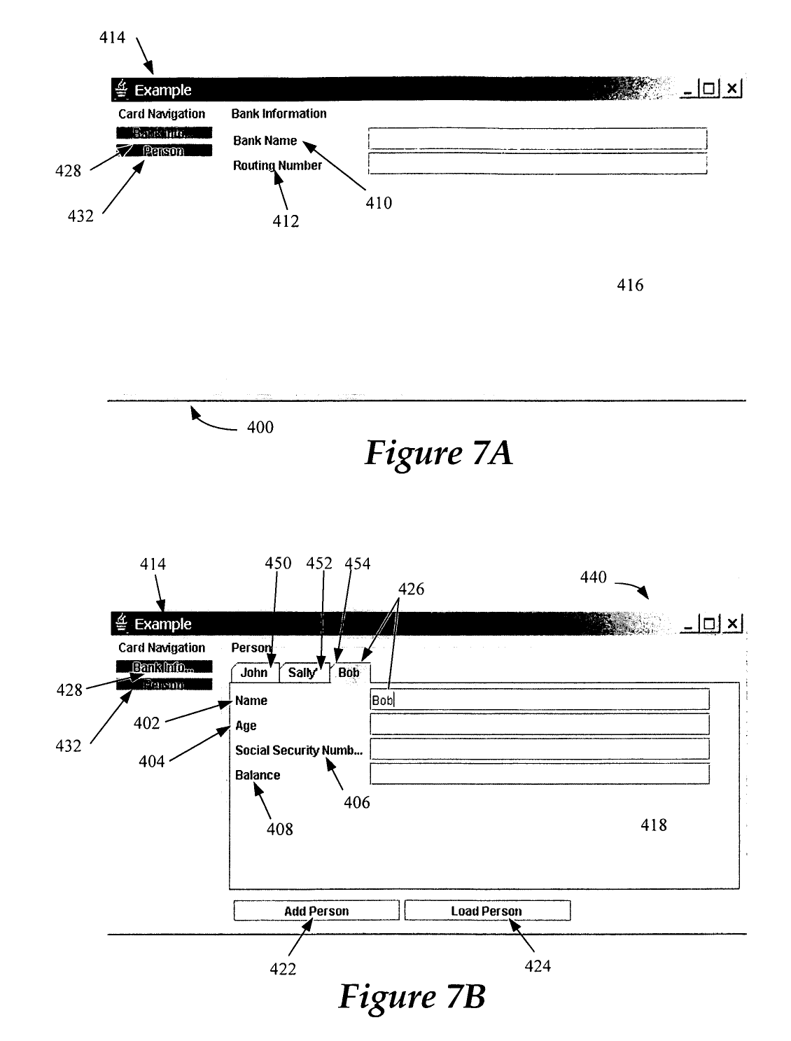

FIGS. 7A and 7B illustrate a data centric GUI created using the present invention indicated by reference numeral 400 and 440. FIGS. 7A and 7B show typical information that might be important to a bank employee; such as Name 402, Age 404, Social Security Number 406 Account Balance 408, Bank Name 410, and Bank Routing Number 412. However, in this example, the typical information that might be important to a bank employee is separated into multiple pages in accordance with the XML code. The XML code needed to generate this GUI is:

<Data name = “example” style = “button navigation”>

<Group name = “Bank Information” style = “default” functionality =
“single

instance”>

<String name = “Bank Name”/>
<Integer name = “Routing Number”/>

</Group>
<Group name = “person” style = “default” functionality =
“multiple instance”>

<String name = “Name”/>
<Integer name = “Age”/>
<Integer name = “Social Security Number”/>
<Double name = “Balance”/>

</Group>

</Data>

As can be seen in the XML code above, the GUI illustrated in FIGS. 7A and 7B are defined to be representative of a Data window having a “button navigation” Style which, allows for multiple pages to displayed within a window. The user is only allowed to see one page at a time, while the other pages are hidden. The user must navigate between pages within the window by engaging the page buttons. As the code and FIGS. 7A and 7B illustrate, in this example, the “Example” frame 414 includes a page labeled “Bank Information” 428 and a Group of data items named “Person” 432. When a user engages the “Bank Information” button 428, the “Bank Information” page 416 within the “Example” window 414 is shown and the “Person”page 418 becomes hidden, as shown in FIG. 7A. When a user engages the “Person”button 432, the “Person” page 418 within the “Example” frame 400, 440 is shown and the “Bank Information” page 416 becomes hidden, as shown in FIG. 4B. The Button navigation function allows the user to switch between the bank information page 416 and the person page 418 by a simple point and click operation via the page navigation area 428, 432.

The person page 418, illustrated in FIG. 7B and defined by the code, shows a “multiple instance” of a Group of data labeled “person” having a “default”Style. The bank information page 416, illustrated in FIG. 7A is a “single instance” of a Group of data items labeled “Bank Information” having a “default” style. The data items within both the bank information Group 416 and the person Group 418 are listed in the order in which the XML document list the data.

FIG. 7B also depicts unique functionality added 120 to the data centric GUI. The data centric GUI shown in FIG. 7B allows a bank employee (bank teller) to load a person(s) 424 from a database, possibly the bank's customers list. Suppose a potential new customer would like to open an account with the bank. Another unique functionality of the data centric GUI provides the ability to add a person 422. A Page listener is also incorporated to update the page name 426 once the data value “Name” has been inputted.

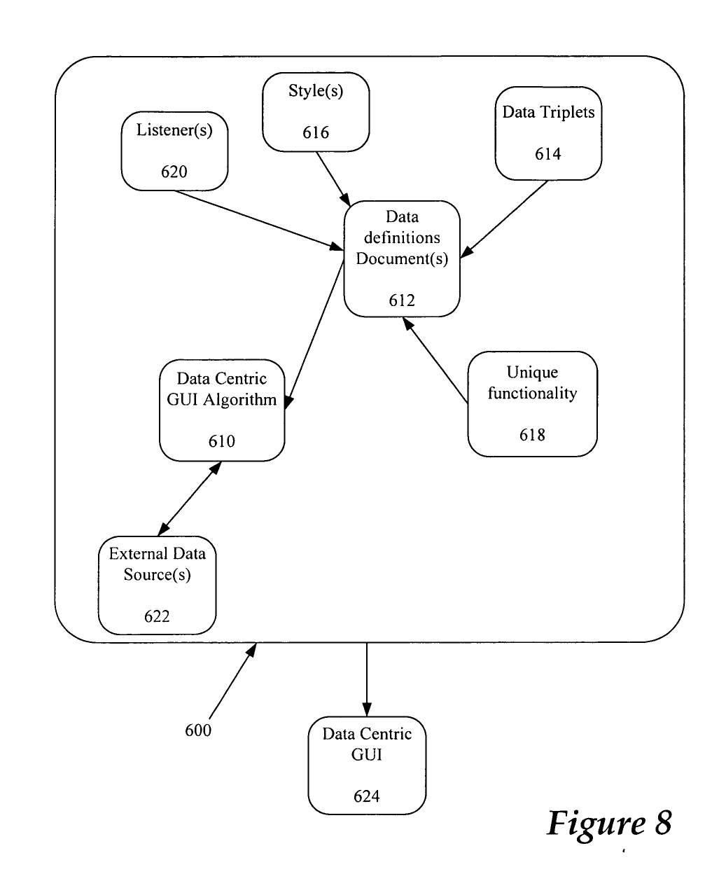

FIG. 8 depicts a system for creating a data centric GUI indicated by reference numeral 600. A list of data triplets 614 is compiled. Actual data value(s) of the triplet are not required for development of the data centric graphical user interface. Data name(s) are any variable(s) that the end user(s) may need to calculate, view, manipulate and/or save. Data type(s) represent the type of data structure the data is. For example, a manner in which a person may be identified could have the data name “Name” and data type “string”, or the data name “Social Security Number” and data type “integer”. Acceptable data type(s) are any valid data structure for a given computer language with which the data centric GUI algorithm 610 is written in.

Once a list of data triplets 614 is compiled, a data definition document 612 is created. In the present embodiment, the data definition document 612 is in an XML format and is created by means of any standard technique used to create XML documents. Examples of standard techniques include but not limited to, hard coding via text editors, or other data centric or non-data centric GUIs.

Style(s) 616 can be incorporated to describe both the overall function and/or appearance of the data centric GUI. These Style(s) 616 can be applied to the data centric GUI's Data Set, Groups and and/or the data items displayed by the GUI. The Style(s) 616 can be customized. Through the customizing of Style(s) the GUI developer will build a library of Style(s) 616 that can be used for future GUI development or to update existing data centric GUIs.

If needed or desired, unique functionality 618 can be added to a data centric GUI. Examples of unique functionality 618 may include, but not limited to, the ability to load and/or save data value(s) from/to an external data source 622 such as a database or the Internet, the ability to add data items 614. Another unique functionality 618 may be the ability to have “multiple instance” of pages within a page (such as pages 450, 452 and 454 within page 418, illustrated in FIG. 7B) viewable by means of a page navigation area 428 as depicted in FIG. 7A and 7B. Listener(s) 620 may also be incorporated as a part of the functionality 618. An example of a page listener is depicted in FIGS. 6, 7A and 7B.

Once the XML document 612 have been created and Style(s) 616 coded along with any required or desirable unique functionality 618 the code at data centric GUI algorithm 610 compiles the XML document 612 and Style(s) 616 to create a data centric GUI 624. The data centric GUI algorithm 610 can be written in either a compliable language or an interpretive programming language. For example, the data centric GUI algorithm 610 can be written in a number of languages including, but not limited to, C/C++, Java-Swing, HTML forms, Servlets, or Visual Basic. The data centric GUI algorithm 610 source code can be transferred across various platforms such as Macintosh®, Linux, Solaris®, Windows®, and/or UNIX.

Various modules and techniques may be described herein in the general context of computer-executable instructions, such as program modules, executed by one or more computers or other devices. Generally, program modules include routines, programs, objects, components, data structures, etc. for performing particular tasks or implement particular abstract data types. Typically, the functionality of the program modules may be combined or distributed as desired in various embodiments.

An implementation of these modules and techniques may be stored on or transmitted across some form of computer readable media. Computer readable media can be any available media that can be accessed by a computer. By way of example, and not limitation, computer readable media may comprise “computer storage media”

and “communications media.” “Computer storage media” includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embodies computer readable instructions, data structures, program modules, or other data in a modulated data signal, such as carrier wave or other transport mechanism. Communication media also includes any information delivery media. The term “modulated data signal” means a signal that has one or more of its characteristics set or changed in such a manner as to encode information in the signal.

Reference has been made throughout this specification to “one embodiment,” “an embodiment,” or “an example embodiment” meaning that a particular described feature, structure, or characteristic is included in at least one embodiment of the present invention. Thus, usage of such phrases may refer to more than just one embodiment. Furthermore, the described features, structures, or characteristics may be combined in any suitable manner in one or more embodiments.

One skilled in the relevant art may recognize, however, that the invention may be practiced without one or more of the specific details, or with other methods, resources, materials, etc. In other instances, well known structures, resources, or operations have not been shown or described in detail merely to avoid obscuring aspects of the invention.

While example embodiments and applications of the present invention have been illustrated and described, it is to be understood that the invention is not limited to the precise configuration and resources described above. Various modifications, changes, and variations apparent to those skilled in the art may be made in the arrangement, operation, and details of the methods and systems of the present invention disclosed herein without departing from the scope of the claimed invention.

We claim:

1. A method of creating a data-centric graphical user interface that is comprising the steps:
a. creating a data definition file that contains data definition;
b. inputting said data definition document into a graphical user interface generation tool that processes said data definition document; and
c. generating a graphical user interface that graphically displays said data definition.

2. The method of claim 1, wherein said data definition file includes style definitions.

3. The method of claim 1, wherein said data definition file includes function definitions.

4. The method of claim 1, wherein said data definition comprises a data set having at least one group of data items configured as triplets that include a data name, data type, and value.

5. The method of claim 1, wherein said data definition file comprises an XML document.

6. The method of claim 1, further comprising a step of adding unique functionality to said data definition document.

7. The method of claim 6, wherein said step of adding unique functionality comprises inputting code into the data definition document that operatively performs said unique functionality.

8. The method of claim 1, wherein said graphical user interface tool is an algorithm written in at least one computer language.

9. The method of claim 8, wherein said at least one computer language comprises:
a. C/C++
b. HTML forms
c. Java-Swing;
d. Servlets; and
e. Visual Basic.

10. A computer-readable medium which stores a set of instructions which when executed performs a method for creating a data-centric graphical user interface, the method executed by the set of instructions comprising:
a. reading a data definition document;
b. processing data definition associated with data within said data definitions document; and
c. generating a GUI displaying said data, wherein said GUI has a configuration defined by the set of instructions.

11. The computer-readable medium of claim 10, wherein said data definition document further includes style definitions associated with said data, said processing step further comprising a step of processing said style definitions and thereby modifying the appearance of the GUI.

12. The computer-readable medium of claim 10, wherein the set of instructions for processing said data definition document and thereby generating a graphical user interface are written in at least one computer language and transferable to a plurality of platforms.

13. The computer-readable medium of claim 10, wherein the set of instructions is in web form.

14. The computer-readable medium of claim 10, wherein said data definition document includes functionality definitions associated with said data, said processing step further comprising a step of processing said functionality definitions and thereby modifying the functionality of widgets within the GUI.

15. The computer-readable medium of claim 10, wherein said data to which said style definitions are associated include at least one of the following:
a. a data set;
b. a group; and
c. a data item.

16. A method for creating a graphical user interface that is data-centric comprising the steps:
a. identifying a data set including at least one group of data triplets;
b. identifying a list of style definitions;
c. creating a data definition file that comprised of said data set and said style definitions wherein said style definitions may be associated with at least one of the following, said data set, said at least one group, and said data triplets; and
d. reading said data definition file into a GUI Generation tool that processes said data set and said style definitions within said data definition document; and
e. generating a GUI that is defined by said GUI generation tool default data definition and said style definitions.

17. The method of claim 16, wherein said data triplets comprise:
a. a data name;
b. a data type; and
c. a data value.

18. The method of claim 16, wherein said data definition file comprises an XML document.

19. The method of claim 16, wherein said style definitions define the appearance of objects within said GUI.

20. The method of claim 16, wherein said data definition file includes functionality definitions associated with data within said data definition file, said GUI generated is further defined by said functionality definitions that control the functionality of widgets within the GUI.
